(19) United States
(12) Patent Application Publication
(10) Pub. No.: US 2006/0070540 A1
(43) Pub. Date: Apr. 6, 2006

(54) Spacer sleeve for printing-press cylinders

(75) Inventors: Alfons Grieser, Sielenbach (DE); Eduard Hoffmann, Bobingen (DE); Angelika Keck, Munchen (DE); Johann Winterholler, Friedberg (DE)

Correspondence Address: COHEN, PONTANI, LIEBERMAN & PAVANE, 551 FIFTH AVENUE, SUITE 1210, NEW YORK, NY, 10176, US

(73) Assignee: MAN Roland Druckmaschinen AG

(21) Appl. No.: 11/243,159

(22) Filed: Oct. 4, 2005

(30) Foreign Application Priority Data
Oct. 6, 2004 (DE) 10 2004 048 634.4

(51) Int. Cl. B41F 27/06

(52) U.S. Cl. 101/376

(57) ABSTRACT

A sleeve, in particular spacer sleeve, for variable-format printing presses, has at least two metallic layers, and at least one dimensionally stable intermediate layer arranged between a first, inner metallic carrier. layer and a second, outer metallic covering layer. The at least one intermediate layer determines the thickness or wall thickness of the sleeve.

### BACKGROUND OF THE INVENTION

The present invention relates to a spacer sleeve for printing-press cylinders of variable-format printing presses.

Spacer sleeves are used in variable-format printing presses to compensate for a change, with printing-press cylinders which remain the same, in the diameter of the printing formes or rubber blankets which results during the format change. Here, the spacer sleeves are pushed onto the respective printing-press cylinder and serve as a carrier for, printing plates or printing sleeves, or else rubber blankets or rubber sleeves.

According to the prior art, spacer sleeves are manufactured from non-metallic materials for reasons of cost and weight. However, spacer sleeves made from non-metallic materials of this type are not precise in terms of their shape and dimensions, with the result that they can be used only to a limited extent, in particular for offset printing. The spacer sleeves which are known from the prior art therefore have to be subjected to a grinding operation to provide the outer diameter of the spacer sleeves with a precise shape and dimensions. Overall, this is a disadvantage.

### SUMMARY OF THE INVENTION

An object of the present invention is to provide a novel spacer sleeve for printing-press cylinders of, in particular, variable-format printing presses.

This object is met by a spacer sleeve having a first inner metallic carrier layer and a second outer metallic covering layer. At least one dimensionally stable intermediate layer is arranged between the first metallic carrier layer and the second metallic covering layer, the at least one intermediate layer determining, in particular, the thickness or wall thickness of the sleeve.

In the context of the present invention, a spacer sleeve for variable-format printing presses is proposed which comprises at least two metallic, sleeve-like or tubular layers, that is to say the first, inner metallic carrier layer and the second, outer metallic covering layer. At least one intermediate layer is positioned between the two sleeve-like, metallic layers. The thickness of the at least one intermediate layer determines the wall thickness of the spacer sleeve. That is, the first and second layers are made of a metallic sheet and the thickness of the at least one intermediate is dimensioned so that the diameter of the spacer sleeve is sized for a particular application. Spacer sleeves can be manufactured precisely in terms of their shape and dimensions with the aid of the present invention, with the result that they can be used, in particular,. for offset printing without any subsequent grinding treatment.

The at least one intermediate layer is advantageously connected fixedly to the inner metallic carrier layer and/or to the outer metallic covering layer.

The at least one dimensionally stable intermediate layer is preferably formed from a metallic or non-metallic material, in particular from a foamed material such as PU foam or metal foam.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

In the drawings, wherein like reference characters denote similar elements throughout the several views:

FIG. 1 is a longitudinal cross sectional view of a spacer sleeve for variable-format printing presses according to an embodiment of the present invention;

FIG. 2 is an axial cross sectional view of the spacer sleeve from FIG. 1, which cross section is offset by 90° with respect to FIG. 1;

FIG. 3 is a longitudinal cross sectional view through a spacer sleeve for variable-format printing presses according to another embodiment of the present invention;

FIG. 4 is a longitudinal cross sectional view through a spacer sleeve for variable-format printing presses according to a further embodiment of the present invention; and

FIG. 5 is a longitudinal cross sectional view through a spacer sleeve for variable-format printing presses according to yet another embodiment of the present invention.

### DETAILED DESCRIPTION OF THE PRESENTLY PREFERRED EMBODIMENTS

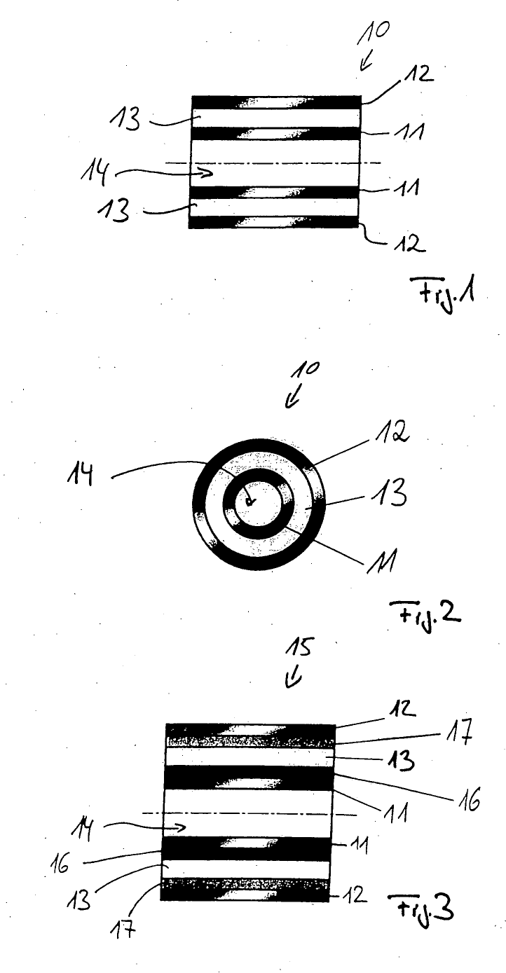

FIGS. 1 and 2 show a first embodiment of a spacer sleeve 10 according to the present invention for a variable-format printing press. The spacer sleeve 10 from FIGS. 1 and 2 includes two sleeve-like, metallic layers, namely, a first layer comprising an inner metallic carrier layer 11 and a second layer comprising an outer metallic covering layer 12. A single dimensionally stable intermediate layer 13 is positioned between the two metallic layers 11 and 12 in the embodiment of FIGS. 1 and 2. The intermediate layer 13 is connected fixedly on one side to the inner metallic carrier layer 11 and on the other side to the outer metallic covering layer 12. The intermediate layer 13 is manufactured from a dimensionally stable material which may be a metallic or non-metallic material. The intermediate layer 13 is preferably composed of a foamed material such as, for example, a PU foam or metal foam.

The inner metallic carrier layer 11 delimits a hollow space 14, by means of which the spacer sleeve 10 can be pushed onto a printing-press cylinder. Accordingly, the inner metallic carrier layer 11 of the spacer sleeve 10 is in contact with the printing-press cylinder when the spacer sleeve is received on the printing press cylinder (the printing press cylinder is not shown in the Figures). The diameter and wall thickness of the spacer sleeve 10 is determined primarily by the thickness of the dimensionally stable intermediate layer 13.

In the embodiment in FIGS. 1 and 2, the spacer sleeve 10 serves as a carrier for a device which forms a functional surface and which can be released or removed from the spacer sleeve 10 without being destroyed. The device may be a printing forme, such as a printing plate or a printing sleeve, or an ink transfer device, such as a rubber blanket or a rubber sleeve. If the spacer sleeve 10 or its outer metallic covering layer 12 serves to accommodate printing sleeves or rubber sleeves, the printing sleeves or rubber sleeves are pushed onto the spacer sleeve 10. For this purpose, holes can then be integrated into the spacer sleeve 10, in order to pull, for example, the printing sleeves or rubber sleeves onto the spacer sleeve 10 more easily with the aid of a pneumatic system.

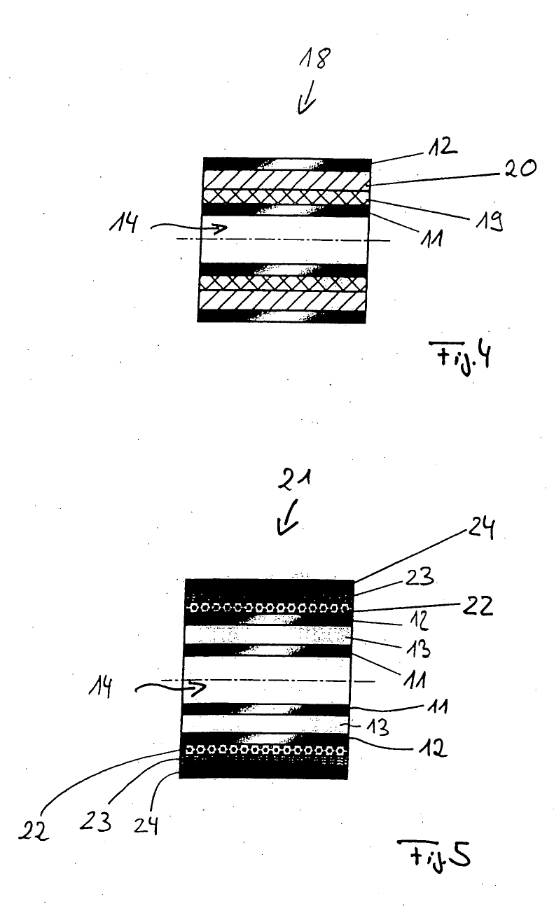

FIG. 3 shows a further embodiment of a spacer sleeve 15 according to the present invention. The spacer sleeve 15 shown in FIG. 3 has two metallic layers and an intermediate layer which is positioned between the two metallic layers, similarly to the spacer sleeve 10 of the embodiment shown in FIGS. 1 and 2. Identical reference numerals are therefore used for identical assemblies in order to avoid unnecessary repetitions, and reference is made to the descriptions relating to the embodiment from FIGS. 1 and 2.

In the exemplary embodiment from FIG. 3, the dimensionally stable intermediate layer 13 is connected fixedly on one side to the inner metallic carrier layer 11 and on the other side to the outer metallic covering layer 12 via in each case one adhesive layer 16 and 17. Here, the adhesive layer 17 is preferably non-compressible, and the adhesive layer 16 is of compressible configuration. In contrast to the embodiment shown, it is also possible for both adhesive layers 16 and 17 to be of non-compressible or else slightly compressible configuration.

FIG. 4 shows a further embodiment of a spacer sleeve 18 according to the present invention. The spacer sleeve 18 from FIG. 4 again has two metallic layers, that is to say an inner metallic carrier layer 11 and an outer metallic covering layer 12. In contrast to the embodiments from FIGS. 1 to 3, the spacer sleeve shown in FIG. 4 has two dimensionally stable intermediate layers 19 and 20 positioned between the two metallic layers 11 and 12. The dimensionally stable intermediate layer 19 adjoins the inner metallic carrier layer 11 and is connected fixedly thereto. The intermediate layer 20 adjoins the outer metallic covering layer 12 and is connected fixedly thereto. Furthermore, the two dimensionally stable intermediate layers 19 and 20 are connected fixedly to one another. In the embodiment from FIG. 4, the intermediate layer 19 is of slightly compressible configuration and the intermediate layer 20 is of non-compressible configuration. It goes without saying that it is also possible to position more than two intermediate layers between the two metallic layers 11 and 12.

In the embodiments shown in FIGS. 1 to 4, the spacer sleeves 10, 15 and 18 shown there all serve for the accommodation of a device which forms a functional surface and which can be released or removed without being destroyed. These devices may be printing formes, such as printing plates or printing sleeves, or ink transfer devices, such as rubber blankets or rubber sleeves. The spacer sleeves 10, 15 and 18 serve primarily to provide diameter compensation in the event of a format change on a printing press. As has been explained already, the thickness or wall thickness of the spacer sleeves is determined primarily via the dimensionally stable intermediate layers.

FIG. 5 shows another embodiment of a spacer sleeve 21 according to the present invention, which again has the two metallic layers 11 and 12 and an intermediate layer 13. In the exemplary embodiment from FIG. 5, a plurality of further layers are applied non-releasably to the outer metallic covering layer 12, that is to say a compressible layer 22, a woven fabric layer 23 and a rubber covering layer 24. The rubber covering layer 24 forms a functional surface which is accordingly a constituent part of the spacer sleeve 21. Accordingly, in the embodiment of FIG. 5, the spacer sleeve is configured as a rubber sleeve which can be used directly as an ink transfer carrier. In the embodiment of FIG. 5, the spacer sleeve 21 therefore directly forms a rubber sleeve.

A common feature of all the spacer sleeves according to the present invention which are shown in FIGS. 1 to 5 is that they have two metallic layers, that is to say an inner metallic carrier layer and an outer metallic covering layer, at least one dimensionally stable intermediate layer being positioned between these two metallic layers. In the mounted state, the inner metallic carrier layer of the spacer sleeves is in contact with a printing-press cylinder. The outer metallic covering layer of the spacer sleeves serves for the accommodation of a device which forms a functional surface and which can be released or, as an alternative, it is also possible for a further functional layer to be applied non-releasably to the outer metallic covering layer.

It is to be pointed out that it is also possible to use the metallic covering layer of the spacer sleeves 10, 15 and 18 of the exemplary embodiments according to FIGS. 1 to 4 directly as a printing forme which can be erased and have images set on it again. The spacer sleeve then forms a printing forme for printing presses which operate according to the direct imaging principle. Printing presses of this type which operate according to the direct imaging principle are marketed by the applicant under the product name “DICOweb”.

Finally, it is to be pointed out that the metallic, sleeve-like layers 11 and 12 of the spacer sleeves are preferably formed from a welded metal sheet. The spacer sleeves according to the present invention can be used as paper guide rolls or can serve as carriers of coated rolls in an inking unit of the printing press.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements which perform substantially the same function in substantially the same way to achieve the same results are within the scope of the invention. Moreover, it should be recognized that structures and/or elements shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. A spacer sleeve for a cylinder of a variable-format printing press, comprising:
at least two metallic layers including an inner metallic carrier layer and an outer metallic covering layer, and
at least one dimensionally stable intermediate layer arranged between said inner metallic carrier layer and said outer metallic covering layer, wherein said at least one intermediate layer determines a wall thickness of said spacer sleeve.

2. The spacer sleeve of claim 1, wherein said inner metallic carrier layer is dimensioned for contacting an outer surface of the cylinder of the printing press when said spacer sleeve is received on the cylinder.

3. The spacer sleeve of claim 1, wherein said at least one intermediate layer is connected fixedly to said inner metallic carrier layer and to said outer metallic covering layer.

4. The spacer sleeve of claim 1, wherein said at least one dimensionally stable intermediate layer includes only a single dimensionally stable intermediate layer arranged between said inner metallic carrier layer and said outer metallic covering layer, said spacer sleeve further comprising a first adhesive layer connecting said intermediate layer to said inner metallic carrier layer and a second adhesive layer connecting said intermediate layer to said outer metallic covering layer.

5. The spacer sleeve of claim 1, wherein said at least one dimensionally stable intermediate layer comprises first and second dimensionally stable intermediate layers arranged between said inner metallic carrier layer and said outer metallic covering layer.

6. The spacer sleeve of claim 5, wherein said first intermediate layer is connected fixedly to said inner metallic carrier layer, said second intermediate layer is connected fixedly to said outer metallic covering layer, and said first and second two intermediate layers are connected fixedly to one another.

7. The spacer sleeve of claim 1, wherein said at least one dimensionally stable intermediate layer comprises a foamed material.

8. The spacer sleeve of claim 1, wherein said outer metallic covering layer is arranged and dimensioned as a carrier for removably accommodating a device which forms a functional surface.

9. The spacer sleeve of claim 8, wherein said outer metallic covering layer arranged and dimensioned as a carrier for accommodating printing formes including printing plates or printing sleeves.

10. The spacer sleeve of claim 8, wherein said outer metallic covering layer is arranged and dimensioned as a carrier for accommodating ink transfer devices including rubber blankets or rubber sleeves.

11. The spacer sleeve of claim 1, wherein said outer metallic covering layer comprises an erasable printing forme such that images are settable thereon.

12. The spacer sleeve of claim 1, further comprising at least one further layer which forms a functional surface applied non-releasably to said outer metallic covering layer.

13. The spacer sleeve of claim 12, wherein said at least one further layer comprises a compressible layer, a woven fabric layer, and a rubber layer applied to said outer metallic covering layer.

14. The spacer sleeve of claim 12, wherein said sleeve is configured as a printing sleeve.

15. The spacer sleeve of claim 7, wherein said foamed material comprises a PU foam or a metal foam.
